(19) United States
(12) Patent Application Publication
(10) Pub. No.: US 2023/0298105 A1
(43) Pub. Date: Sep. 21, 2023

(54) SYSTEM AND METHOD FOR PROVIDING A DISABILITY BENEFIT TO AN INDIVIDUAL

(71) Applicant: Guardian Life Insurance Company of America, New York, NY (US)

(72) Inventors: Donna Owens, Milford, MA (US); Michael Palmieri, Pittsfield, MA (US); William L. Eurbin, Pittsfield, MA (US)

(73) Assignee: Guardian Life Insurance Company of America, New York, NY (US)

(21) Appl. No.: 18/121,832

(22) Filed: Mar. 15, 2023

Related U.S. Application Data
(60) Provisional application No. 63/319,811, filed on Mar. 15, 2022.

(51) Int. Cl. G06Q 40/08

(52) U.S. Cl. CPC G06Q 40/08

(57) ABSTRACT

A system and method for providing a disability benefit to an individual includes a server; a memory storage on a network or cloud; a database, wherein the server, the storage, and the database are connected via communication links on the network; and one or more end user personal devices, wherein the personal devices are coupled to the network via the communication links. In addition, the system and method includes receiving a request, via an end-user personal device, from the individual for an insurance policy; determining the eligibility of the individual for insurance policy coverage, electronically generating and electronically notifying the individual of the determined insurance coverage via the end-user personal device, electronically displaying the determined insurance coverage on the end-user personal device, and accepting the determined insurance coverage by the individual, via the end-user personal device.

The present invention relates to a system, a computer implemented method and a computer readable medium for providing a disability benefit to a whole life term policy (and long term care) to an individual. Payment of the disability benefit is conditioned upon the fulfillment of two or more requirements and is paid upon satisfaction of those requirements.

### BACKGROUND OF THE DISCLOSURE

A number of insurance products exist within the insurance industry to provide one specific type of coverage or benefit. Mixing different types of coverages via a rider may address certain individual protection needs, such as insurance policies that provide whole life benefits, long-term disability benefits and long-term care benefits via separate individual polices. This may be available through insurance companies such as Massachusetts Mutual Life Insurance Company, New York Life Insurance Company or Northwestern Mutual Life Insurance Company.

However, there is an unfilled need in the marketplace for a holistic approach to life's personal financial protection needs that can combine different types of benefits in one transaction. Specifically, the availability of a disability benefit that, when attached to a life insurance product that includes Long Term Care benefits, provides comprehensive personal financial protection during the individual's lifetime. This has not been provided because of the enormous amount of time it takes to account for sets of insurance-related regulations (e.g., long term care, death benefits, and disability benefits, life benefits, etc.).

### SUMMARY OF THE INVENTION

The present invention provides an insurance product that provides life benefits, long-term care benefits, and long-term disability benefits under a single insurance product and process.

The present invention provides a system and a method for providing this novel insurance solution to a customer, as well as a system and a method for determining and paying out of benefits that may include a death benefit, waiver of premium and a monthly indemnity disability benefit, and/or benefits specific to long term care needs.

The present invention provides a system and method for generating a single whole life product with an attached long-term care and long-term disability benefit riders in a single transaction, the intent of the disability benefit rider is to provide disability benefits for an insured when attached to any personal insurance product.

A novel idea of the present invention is a holistic approach to applying a rider to a whole life policy with long term care and disability benefits. A single underwriting process and a single set of under writing rules may be used for all three—death benefits, long term care, and disability benefits. It is one risk assessment model and application for whole life policy, long term care and disability benefits. It is also a one claim process. This improved process expands to concept of underwriting communication in both the field and with customers. The improvement of the present invention also provides a new technology solution to adjudicate all benefits in one claim process.

### BRIEF DESCRIPTION OF THE DRAWINGS

The accompanying drawings, which are included to provide a further understanding of the disclosure, are incorporated to constitute a part of this specification, illustrate embodiments of the disclosure and, together with the detailed description, serve to explain the principles of the present invention. No attempt is made to show structural details of the disclosure in more detail than may be necessary for a fundamental understanding of the disclosure and the various ways in which it may be practiced. In the drawings:

FIG. 1 shows an exemplary embodiment of a system for generating a policy and a rider, and paying out a disability benefit under the policy and rider to the insured;

FIG. 2 shows an exemplary flow chart of the present invention for a process for offering and generating a disability benefit rider to a customer; and

FIGS. 3a, 3b and 3c show exemplary flow charts of the present invention for a process for determining and paying a policy benefit(s) to an insured.

### DETAILED DESCRIPTION

The present invention provides a system and method for providing a disability benefit to a whole life policy to which it is attached. The system is comprised of a server, cloud or computer that may be connected to a network, a database, and one or more end-user personal devices, such as a computer, smartphone, etc. The system is configured to generate both a policy and one or more riders, which may be provided to a customer. All provisions of the policy may apply to the rider(s) and remain the same, except where the provisions are changed by the rider(s).

According to an embodiment of the present invention, a disability benefit may be paid to an insured if one of the following conditions are met: the policy and rider are in force as of the date of disability, and/or the insured is totally disabled during the elimination period. The subsequent benefit may be for a continuing total disability or, if the insured returns to work on a limited basis, a partial benefit. Should the insured satisfy the conditions related to disability subject to the terms and limitations defined in the rider, the additional benefit provided may be waiving premiums to the policy to which the disability rider is attached. This will eliminate not only a separate rider for the insured, but also incorporate one process to deliver two outcomes.

A single premium is provided to the insured for the whole life policy, the attached long-term care benefit rider, and/or the attached long-term disability rider and shown on a policy specification page for the policy or the like for each attached rider. The premium for the rider may be provided and shown on a rider specification page that includes the expiration date of the rider.

The whole life policy, attached long-term care benefit rider, and/or attached long-term disability rider may terminate. The whole life policy may terminate if it is surrendered or lapsed without value, the period of extended term insurance has ended, the death benefit has been paid, or any required loan payment is not made in accordance with a loan repayment provision in the policy. The Long-Term Care rider may expire on the earliest of the following dates: the date of the insured's death, the date an Accelerated Benefit Rider is exercised for Terminal Illness (if attached), the date the Accumulated Long Term Care (LTC) Amount equals the Total LTC Pool, upon receipt of the owner's proper written request for cancellation, the date the Policy goes on Policy Value Option, or the date the Policy is surrendered for its cash value. The Disability Benefit rider may expire when the first of the following occurs: the Rider Expiration Date, the date the policy terminates, the date of the insured's death, the date the premium for the policy or the rider is unpaid at the end of the grace period, the premium for the rider remains unpaid for more than 90 days after the end of a suspension for active military service, receipt of the owner's written request for cancellation of the rider, or a Policy Value Option is elected.

This present invention also provides a computer implemented method for providing death benefits to a designated beneficiary, pre-determined amount over a pre-determined number of days or months of long-term care benefits to an insured, and/or long-term disability benefits to an insured for total or partial disability over a pre-determined number of days (months or years) within a single insurance policy. A shared platform is provided for managing a single stream application process, initiated either by electronic or paper means, then continues through an underwriting workflow to evaluate financial, medical, and occupational risk resulting in a product that can provide benefits for a death, funds for long-term care services, or a monthly disability benefit. This also simplifies post-issue administration.

According to an embodiment of the invention, certain benefits are available to the insured rather than a beneficiary of the insured. A disability benefit may be paid out to an insured if a sickness or injury occurs and the insured is unable to work at all or on a limited basis. This determination may also result in waiving the policy's premium and will be waived if the following conditions are met: the insured remains disabled, and the rider and policy is in force. Premiums may be waived for life if the total disability begins before age 60 and the insured remains totally disabled until age 65 and premiums have been waived during that period. This determination may also initiate benefits under the Long-Term Care Acceleration of Benefits rider if it is also attached to the policy.

The system of the present invention will process these benefits for the insured integrating the long term and/or disability benefits with the existing life claims platform. This not only enables a single view of the policy that can provide not only disability (total or partial), waiver of premium or death benefits, but also supports required downstream outputs and analyses such as loss ratio, valuation, reserving, active or disabled lives reporting through the one system.

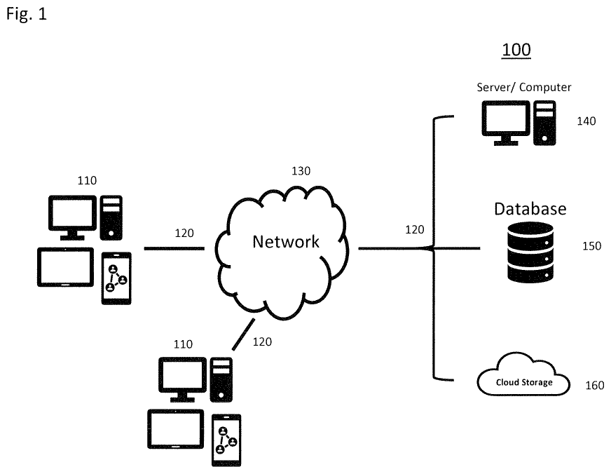

FIG. 1. shows an exemplary embodiment of the present invention providing a system for generating a policy and riders and paying out a disability benefit and/or long-term care benefit under the policy and riders to the insured, as well as waiving policy premiums. System 100 includes server (or computer) 140, database 150, and cloud storage 160. All these systems may be connected to each other and/or a network 130 via one or more communication links 120. A plurality of end-user personal devices 110 may be coupled to the network 130 via communication links 120.

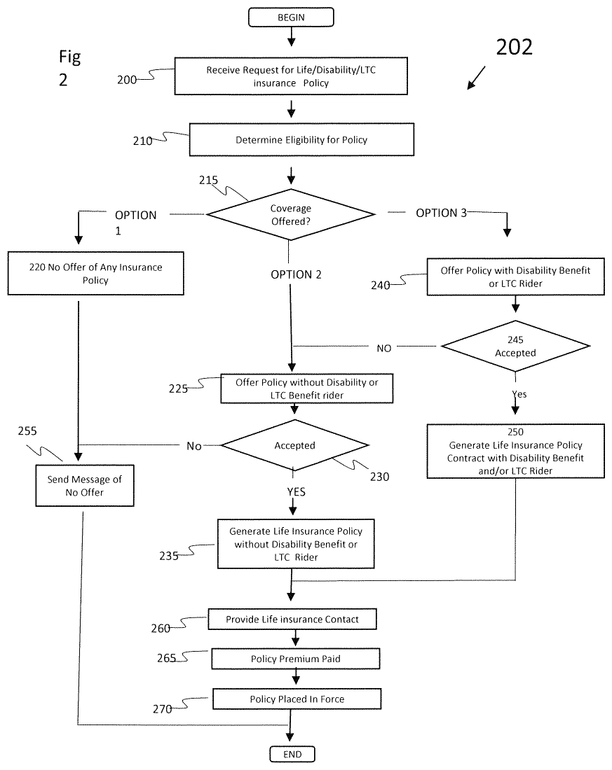

FIG. 2. shows a flow chart of an exemplary embodiment of the present invention of a process 202 for offering and generating a long term and/or disability benefit rider to a customer's life insurance policy. Process 202 may be carried out by, for example, server 140. Initially, a request for an insurance policy may be received 200. Based on the requested policy, eligibility for policy must be determined 210, one of three options may be determined of the coverage offered 215. The options include, not to offering any coverage 220, offering a policy without a disability benefit rider or long-term care rider 225, or offering a policy with a disability benefit rider and long-term care rider 240.

If a determination is made to not offer any coverage 220, a message may be generated and sent 255 to the end-user device 110. The message may notify the end-user that an insurance policy or product is not available for the customer.

If a determination is made to offer a life insurance policy without a long-term care and/or a disability benefit rider 225, then the life insurance policy may be offered to the customer without a disability benefit and long-term care rider. If the customer accepts the life insurance policy without the disability benefit and long-term care rider 230, then a life insurance contract may be generated 235 and provided to the customer 260 via end-user device 110. If the customer rejects the life insurance policy, then a message may be generated and sent to end-user device 110. The message may include, for example, an offer for another insurance product. If the customer accepts the offered whole life policy, after the policy premium is received from the customer 265, the policy may be placed into force 270.

If a determination is made that the customer is eligible to be offered a life insurance policy with the disability benefit and/or long-term care rider 240, then the life insurance policy is offered to the customer with a disability benefit and/or long-term care rider. If the customer accepts the life insurance policy with the disability benefit and/or long-term care rider 245, then a life insurance contract may be generated 250 and provided to the customer 260 via end-user device 110. If the customer rejects the life insurance policy with the disability and long-term care riders, then a message may be generated and sent to end-user device 110. The message may include, for example, an offer for another insurance product, such as the policy alone at step 260. If the customer accepts the provided product, after the policy premium is received from the customer 265, the policy (with or without the rider(s)) may be placed into force 270.

The disability benefit rider may be, for example, an optional feature for Guardian Life Insurance Company of America's individual whole life policy form L99, or the like. The disability benefit rider may provide monthly disability benefits to the insured as well as waiving the premium for the whole life policy while the insured is disabled.

An insured may be eligible for a disability benefit when the life policy and disability rider are in force. Unique factors of the present disclosure include incorporating four consumer benefits within the disability benefit rider, such as, a monthly disability indemnity benefit to replace lost income; waiving premiums during a disability for the life insurance policy to which the rider is attached; benefits for either total or partial disability; and/or one claim process to determine eligibility for benefits related to the insured's disability.

According to an aspect of the present invention, a computer readable medium is provided containing a computer program, which, when executed on, for example, server 140, causes process 202 in FIG. 2 to be carried out. The computer program may be tangibly embodied in a computer readable medium, comprising a code segment or code section for each of the steps 200 through 260.

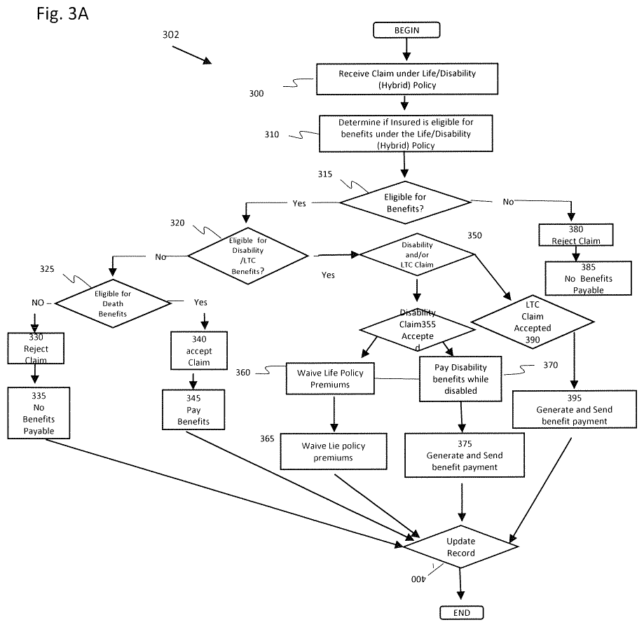

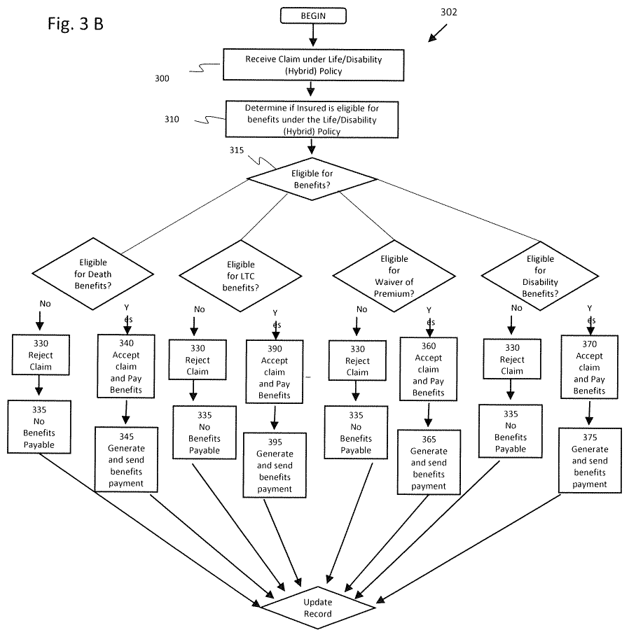

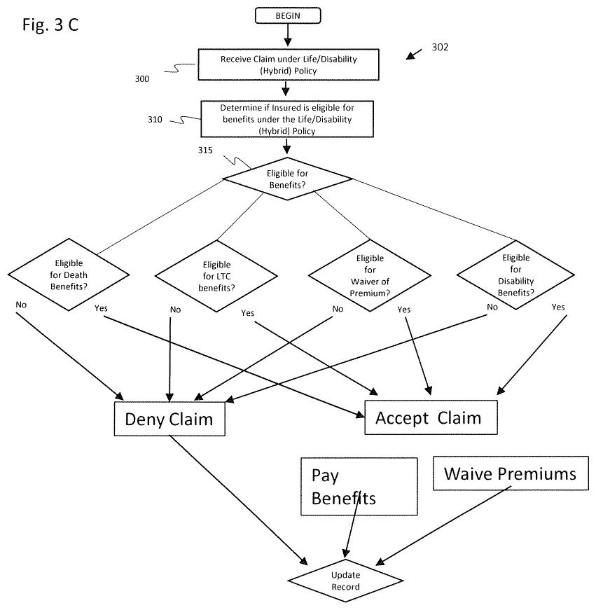

FIGS. 3a, 3b and 3c show examples of process 302 for determining and paying out a policy benefit to an insured. Initially, a claim is received from a claimant 300 (or, for example, an insured, a proxy, or the like) under a policy. The policy may be, for example, a whole life policy, that includes a disability benefits rider and/or a long-term care rider. It is then determined if the insured is eligible for benefits under the life insurance and disability hybrid policy 310. If eligible for benefits, YES at Step 310, a determination is made on what type of benefit is available 315: such as death benefits 325, disability benefits and/or long-term care benefits 320.

If a claim is eligible for long term care and/or disability benefits 320, a determination is made on which disability benefits are to be paid 350, long term care and/or disability. If the claim is eligible for long-term care benefits 320, the claim is accepted and a determination is made on which long-term care benefit is to be paid 390, a benefit is generated 395 and the policy record is updated 400. If a disability benefit is determined and accepted 355, it is further determined which benefits apply, such as waive the life insurance policy premium 360 and/or pay disability when insured is disabled 370. If the determination is to waive life policy premiums 360, then the life policy and rider premiums are waived 365 and the policy record updated 400. If the insured is totally disabled for a certain period of time, for example, 180 days, the premium for the entire product may be waived. If it is determined the disability benefit is to be a monthly indemnity and the claim is accepted 355, then a determination may be made that the insured is eligible to receive monthly disability being a full monthly payment (total disability) or a partial monthly payment (partial disability) while the insured remains disabled 370. A benefit is generated 375 and the policy record is updated 400.

If the insured is determined to not be disabled under the rider (NO at Step 320), then the determination may be made if the claim is eligible for a death benefit 325. If the claim is eligible for a death benefit (YES at Step 325), then a claim is accepted 340 and policy benefits are paid 345 according to option selected by beneficiary(ies). If the insured is determined to not be eligible for death benefits, the claim may be rejected 330 and no benefits are payable 335. If the policy claim is not eligible for benefits 315, the claim may be rejected 380 and no benefits payable 385.

It is important to note that the outcomes of a disability claim, waiving of life insurance premiums and a long-term claim, Steps 355, 365 and 390, respectively, are concurrent and not mutually exclusive. The insured may receive a waiver of life insurance policy premium benefit, a disability benefit, and a long-term care benefit from one claim.

According to an embodiment of the present invention, a computer readable medium is provided containing a computer program, which when executed on, for example, server 140 (shown in FIG. 1), causes the process 302 in FIGS. 3a, 3b and 3c to be carried out. The computer program may be tangibly embodied in the computer readable medium, comprising a code segment or code section for each of the steps in process 302, including Steps 300-400.

The disclosure can be practiced with modifications in the spirit and scope of the appended claims. These examples are merely illustrative and are not meant to be an exhaustive list of all possible designs, embodiments, applications, or modifications of the disclosure.

### GENERAL

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims

What is claimed is:

1. A computer implemented method for providing a single transaction for providing disability benefits to a whole life policy to an individual, the method comprising:
receiving a request, via an end-user personal device, from the individual for an insurance policy;
determining the eligibility of the individual for insurance policy coverage, via a computer, wherein the individual is either not eligible for any insurance coverage, the individual is eligible for insurance coverage including only a life insurance policy, or the individual is eligible for insurance coverage including the life insurance policy, a long term care rider and a disability benefits rider;
electronically generating and electronically notifying the individual of the determined insurance coverage via the end-user personal device,
electronically displaying the determined insurance coverage on the end-user personal device,
accepting the determined insurance coverage by the individual, via the end-user personal device, wherein when filing a claim, the individual electronically submits a single claim under the determined insurance coverage policy, an outcome is concurrently determined regarding a potential death benefit, potential disability claims, a potential waiving of life insurance premiums and a potential disability claim, and
storing the determined insurance coverage in an electronic database or an electronic cloud storage device.

2. The method as recited in claim 1, further comprising generating the insurance coverage contract when the individual accepts the determined insurance coverage, providing the insurance coverage contract to the individual, requesting payment of a policy premium and placing the policy in force upon receipt of the policy premium payment, wherein a single policy premium is paid for all insurance coverage.

3. The method as recited in claim 1, further comprising offering another insurance product if the individual rejects the first determined insurance coverage.

4. The method as recited in claim 1, wherein providing disability benefits to the individual after suffering a disability, the benefits include providing a monthly disability indemnity benefit to replace lost income and waiving the single policy premium during the disability.

5. A system for generating a one transaction life policy having one or more riders, and paying out all relevant disability benefits when approved, the system comprising:
a server;
a memory storage on a network or cloud;
a database, wherein the server, the storage, and the database are connected via communication links on the network; and
one or more end user personal devices, wherein the personal devices are coupled to the network via the communication links.

6. A single transaction insurance product providing comprehensive personal financial protection during an individual's lifetime, the product comprising:
availability of disability benefits, life insurance benefits, and long term care benefits.
